(19) United States
(12) Patent Application Publication
(10) Pub. No.: US 2013/0094689 A1
(43) Pub. Date: Apr. 18, 2013

(54) Microphone Unit, Method of Manufacturing Microphone Unit, Electronic Apparatus, Substrate for Microphone Unit and Method of Manufacturing Substrate for Microphone Unit

(71) Applicants: Funai Electric Co., Ltd., Daito-shi (JP); Hitachi Chemical Company, Ltd., Tokyo (JP)

(72) Inventors: Fuminori TANAKA, Daito-shi (JP); Yuji Ushiyama, Ishioka-shi (JP)

(73) Assignees: Hitachi Chemical Company, Ltd., Tokyo (JP); Funai Electric Co., Ltd., Daito-shi (JP)

(21) Appl. No.: 13/649,297

(22) Filed: Oct. 11, 2012

(30) Foreign Application Priority Data
Oct. 12, 2011 (JP) 2011-225287

(51) Int. Cl. H04R 19/04; H04R 31/00

(52) U.S. Cl. 381/355; 29/594

(57) ABSTRACT

This microphone unit includes a vibrating portion converting a sound to an electric signal, a substrate having a first surface where the vibrating portion is set and a second surface opposite to the first surface and including a hollow portion transmitting a sound therein, and a coating layer formed on an inner surface of the hollow portion of the substrate. The substrate further includes a first substrate sound hole portion provided on the first surface for causing the hollow portion and the vibrating portion to communicate with each other, a second substrate sound hole portion provided on the first surface for causing the hollow portion and the exterior to communicate with each other, and a coating liquid draining hole portion provided on the second surface for causing the hollow portion and the exterior to communicate with each other.

### BACKGROUND OF THE INVENTION

1. Field of the Invention

The present invention relates to a microphone unit, a method of manufacturing a microphone unit, an electronic apparatus, a substrate for a microphone unit and a method of manufacturing a substrate for a microphone unit, and more particularly, it relates to a microphone unit including a substrate having a hollow portion, a method of manufacturing a microphone unit including a substrate having a hollow portion, an electronic apparatus including a microphone unit including a substrate having a hollow portion, a substrate for a microphone unit having a hollow portion, and a method of manufacturing a substrate for a microphone unit having a hollow portion.

2. Description of the Background Art

A microphone unit including a substrate having a hollow portion is known in general, as disclosed in Japanese Patent Laying-Open No. 2010-147955, for example.

The aforementioned Japanese Patent Laying-Open No. 2010-147955 discloses a microphone unit including a circuit element (vibrating portion) and a circuit board (substrate) including a cavity portion (hollow portion) transmitting sounds therein. In this microphone unit, the circuit board further includes a through-hole (first substrate sound hole portion) causing the cavity portion and the circuit element to communicate with each other and another through-hole (second substrate sound hole portion) causing the cavity portion and the exterior to communicate with each other. The cavity portion of the circuit board is formed by removing conductive foil in the substrate by etching. The through-holes of the circuit board are formed by working a glass epoxy substrate.

In the microphone unit according to the aforementioned Japanese Patent Laying-Open No. 2010-147955, however, the cavity portion (hollow portion) is formed by removing the conductive foil in the substrate by etching and the through-holes (first and second substrate sound hole portions) of the circuit board (substrate) are formed by working the glass epoxy substrate, and hence dust such as conductive foil fragments and chips of the glass epoxy substrate disadvantageously collects on the cavity portion. Therefore, the dust disadvantageously enters the circuit element (vibrating portion) communicating with the cavity portion.

### SUMMARY OF THE INVENTION

The present invention has been proposed in order to solve the aforementioned problem, and an object of the present invention is to provide a microphone unit, a method of manufacturing a microphone unit, an electronic apparatus, a substrate for a microphone unit and a method of manufacturing a substrate for a microphone unit, each capable of inhibiting dust from entering a vibrating portion communicating with a hollow portion.

A microphone unit according to a first aspect of the present invention includes a vibrating portion converting a sound to an electric signal, a substrate having a first surface where the vibrating portion is set and a second surface opposite to the first surface and including a hollow portion transmitting a sound therein, and a coating layer formed on an inner surface of the hollow portion of the substrate, while the substrate further includes a first substrate sound hole portion provided on the first surface for causing the hollow portion and the vibrating portion to communicate with each other, a second substrate sound hole portion provided on the first surface for causing the hollow portion and the exterior to communicate with each other, and a coating liquid draining hole portion provided on the second surface for causing the hollow portion and the exterior to communicate with each other.

In the microphone unit according to the first aspect of the present invention, as hereinabove described, the coating layer formed on the inner surface of the hollow portion of the substrate is so provided that the hollow portion is coated with the coating layer, whereby the hollow portion can be inhibited from collecting dust such as chips. Further, the coating liquid draining hole portion causing the hollow portion and the exterior to communicate with each other is so provided that a coating liquid employed for forming the coating layer can be easily drained through the coating liquid draining hole portion, whereby the hollow portion can be inhibited from collecting dust such as a residue of the coating liquid. In addition, external sound penetration as well as external dust penetration can be prevented by sealing the coating liquid draining hole portion. Thus, dust can be inhibited from entering the vibrating portion communicating with the hollow portion. Further, the first and second substrate sound hole portions are provided on the first surface while the coating liquid draining hole portion is provided on the second surface opposite to the first surface so that the first and second substrate sound hole portions and the coating liquid draining hole portion are arranged on the sides of the hollow portion opposite to each other, whereby the coating liquid employed for forming the coating layer can be easily drained through the coating liquid draining hole portion along the first and second substrate sound hole portions serving as air holes.

In the aforementioned microphone unit according to the first aspect, the substrate preferably includes a first substrate layer, a second substrate layer and a third substrate layer arranged on a side of the second substrate layer opposite to the first substrate layer, the first substrate sound hole portion and the second substrate sound hole portion are preferably formed on the first substrate layer, the hollow portion is preferably formed on the second substrate layer, the coating liquid draining hole portion is preferably formed on the third substrate layer, and the coating liquid draining hole portion is preferably sealed from the side of the second surface arranged on the side of the third substrate layer opposite to the second substrate layer. According to this structure, the substrate having the first and second substrate sound hole portions, the hollow portion and the coating liquid draining hole portion can be easily formed by stacking the first, second and third substrate layers individually provided with the first and second substrate sound hole portions, the hollow portion and the coating liquid draining hole portion.

In the aforementioned microphone unit according to the first aspect, the coating liquid draining hole portion is preferably arranged between an end portion of the first substrate sound hole portion opposite to the second substrate sound hole portion and an end portion of the second substrate sound hole portion opposite to the first substrate sound hole portion in plan view. According to this structure, the coating liquid draining hole portion communicating with the hollow portion can be formed on a position between the first and second substrate sound hole portions, whereby the coating liquid employed for forming the coating layer on the hollow portion can be excellently drained. Thus, the coating layer can be uniformly formed.

In the aforementioned microphone unit according to the first aspect, the coating liquid draining hole portion is preferably sealed with a sealing member different from the substrate. According to this structure, the coating liquid draining hole portion can be easily sealed with the member different from the substrate, whereby dust can be easily prevented from penetrating the hollow portion through the coating liquid draining hole portion.

In this case, the coating liquid draining hole portion is preferably sealed by being filled up with a sealing material. According to this structure, the coating liquid draining hole portion can be reliably sealed with the sealing material charged into the same.

In the aforementioned structure in which the coating liquid draining hole portion is filled up with the sealing material, the sealing material is preferably charged up to a portion close to the boundary between the coating liquid draining hole portion and the hollow portion. According to this structure, irregularities of the hollow portion, serving as a sound transmission path, around the coating liquid draining hole portion can be so reduced that the hollow portion can smoothly transmit the sound.

In the aforementioned structure sealing the coating liquid draining hole portion with the sealing member, the coating liquid draining hole portion is preferably sealed by being covered with a sealing film stuck to the second surface. According to this structure, the coating liquid draining hole portion can be easily sealed by sticking the sealing film to the second surface.

In the aforementioned structure sealing the coating liquid draining hole portion with the sealing member, the coating liquid draining hole portion is preferably sealed with the coating layer. According to this structure, the coating liquid draining hole portion can be easily sealed with the same coating layer as that coating the inner surface of the hollow portion.

In the aforementioned structure sealing the coating liquid draining hole portion with the sealing member, the microphone unit preferably further includes a solder joint pad arranged on a region of the second surface surrounding the coating liquid draining hole portion, and the solder joint pad is preferably soldered to a packaging substrate packaged with the microphone unit so that the coating liquid draining hole portion is sealed at least with the packaging substrate and the solder joint pad. According to this structure, the coating liquid draining hole portion is sealed with the packaging substrate and the solder joint pad at the same time when the microphone unit is packaged on the packaging substrate, whereby no step for sealing the coating liquid draining hole portion may be separately provided.

In the aforementioned microphone unit according to the first aspect, the coating layer is preferably formed by plating. According to this structure, the coating layer can be easily formed by plating.

In the aforementioned microphone unit according to the first aspect, the coating liquid draining hole portion is preferably arranged on the outside of a region between the first substrate sound hole portion and the second substrate sound hole portion in plan view. According to this structure, irregularities of the sound transmission path can be reduced by arranging the coating liquid draining hole portion on the outside of the sound transmission path, whereby the sound transmission path can smoothly transmit the sound.

A method of manufacturing a microphone unit according to a second aspect of the present invention includes steps of forming a hollow portion transmitting a sound in a substrate having a first surface where a vibrating portion converting a sound to an electric signal is set and a second surface opposite to the first surface, forming a first substrate sound hole portion causing the hollow portion and the vibrating portion to communicate with each other on the first surface of the substrate, forming a second substrate sound hole portion causing the hollow portion and the exterior to communicate with each other on the first surface of the substrate, forming a coating liquid draining hole portion causing the hollow portion and the exterior to communicate with each other on the second surface, forming a coating layer on an inner surface of the hollow portion of the substrate, and sealing the coating liquid draining hole portion after the formation of the coating layer.

In the method of manufacturing a microphone unit according to the second aspect of the present invention, as hereinabove described, the step of forming the coating layer on the inner surface of the hollow portion of the substrate is so provided that the hollow portion is coated with the coating layer, whereby the hollow portion can be inhibited from collecting dust such as chips. Further, the step of forming the coating liquid draining hole portion causing the hollow portion and the exterior to communicate with each other is so provided that a coating liquid employed for forming the coating layer can be easily drained through the coating liquid draining hole portion, whereby the hollow portion can be inhibited from collecting dust such as a residue of the coating liquid. In addition, the step of sealing the coating liquid draining hole portion is so provided that external sound penetration as well as external dust penetration can be prevented. Thus, a microphone unit capable of inhibiting dust from entering the vibrating portion communicating with the hollow portion can be easily manufactured. Further, the first and second substrate sound hole portions are provided on the first surface while the coating liquid draining hole portion is provided on the second surface opposite to the first surface so that the first and second substrate sound hole portions and the coating liquid draining hole portion are arranged on the sides of the hollow portion opposite to each other, whereby the coating liquid employed for forming the coating layer can be easily drained through the coating liquid draining hole portion along the first and second substrate sound hole portions serving as air holes.

The aforementioned method of manufacturing a microphone unit according to the second aspect preferably further includes a step of forming the substrate including a first substrate layer, a second substrate layer and a third substrate layer arranged on a side of the second substrate layer opposite to the first substrate layer, while the step of forming the first substrate sound hole portion preferably includes a step of forming the first substrate sound hole portion on the first substrate layer, the step of forming the second substrate sound hole portion preferably includes a step of forming the second substrate sound hole portion on the first substrate layer, the step of forming the hollow portion preferably includes a step of forming the hollow portion on the second substrate layer, the step of forming the coating liquid draining hole portion preferably includes a step of forming the coating liquid draining hole portion on the third substrate layer, and the step of sealing the coating liquid draining hole portion preferably includes a step of sealing the coating liquid draining hole portion from the side of the second surface arranged on the side of the third substrate layer opposite to the second substrate layer. According to this structure, the substrate having the first and second substrate sound hole portions, the hollow portion and the coating liquid draining hole portion can be easily formed by stacking the first, second and third substrate layers individually provided with the first and second substrate sound hole portions, the hollow portion and the coating liquid draining hole portion.

In the aforementioned method of manufacturing a microphone unit according to the second aspect, the step of forming the coating liquid draining hole portion preferably includes a step of forming the coating liquid draining hole portion between an end portion of the first substrate sound hole portion opposite to the second substrate sound hole portion and an end portion of the second substrate sound hole portion opposite to the first substrate sound hole portion in plan view. According to this structure, the coating liquid draining hole portion communicating with the hollow portion can be formed on a position between the first and second substrate sound hole portions, whereby the coating liquid employed for forming the coating layer on the hollow portion can be excellently drained. Thus, the coating layer can be uniformly formed.

In the aforementioned method of manufacturing a microphone unit according to the second aspect, the step of sealing the coating liquid draining hole portion preferably includes a step of sealing the coating liquid draining hole portion with a sealing member different from the substrate. According to this structure, the coating liquid draining hole portion can be easily sealed with the member different from the substrate, whereby dust can be easily prevented from penetrating the hollow portion through the coating liquid draining hole portion.

An electronic apparatus according to a third aspect of the present invention includes a microphone unit, while the microphone unit includes a vibrating portion converting a sound to an electric signal, a substrate having a first surface where the vibrating portion is set and a second surface opposite to the first surface and including a hollow portion transmitting a sound therein, and a coating layer formed on an inner surface of the hollow portion of the substrate, the substrate further includes a first substrate sound hole portion provided on the first surface for causing the hollow portion and the vibrating portion to communicate with each other, a second substrate sound hole portion provided on the first surface for causing the hollow portion and the exterior to communicate with each other, and a coating liquid draining hole portion provided on the second surface for causing the hollow portion and the exterior to communicate with each other, and the coating liquid draining hole portion is sealed.

In the electronic apparatus according to the third aspect of the present invention, as hereinabove described, the coating layer formed on the inner surface of the hollow portion of the substrate is so provided that the hollow portion is coated with the coating layer, whereby the hollow portion can be inhibited from collecting dust such as chips. Further, the coating liquid draining hole portion causing the hollow portion and the exterior to communicate with each other is so provided that a coating liquid employed for forming the coating layer can be easily drained through the coating liquid draining hole portion, whereby the hollow portion can be inhibited from collecting dust such as a residue of the coating liquid. In addition, external sound penetration as well as external dust penetration can be prevented by sealing the coating liquid draining hole portion. Thus, an electronic apparatus including a microphone unit capable of inhibiting dust from entering the vibrating portion communicating with the hollow portion can be obtained. Further, the first and second substrate sound hole portions are provided on the first surface while the coating liquid draining hole portion is provided on the second surface opposite to the first surface so that the first and second substrate sound hole portions and the coating liquid draining hole portion are arranged on the sides of the hollow portion opposite to each other, whereby the coating liquid employed for forming the coating layer can be easily drained through the coating liquid draining hole portion along the first and second substrate sound hole portions serving as air holes.

A substrate for a microphone unit according to a fourth aspect of the present invention includes a substrate having a first surface where a vibrating portion converting a sound to an electric signal is set and a second surface opposite to the first surface and including a hollow portion transmitting a sound therein and a coating layer formed on an inner surface of the hollow portion of the substrate, while the substrate further includes a first substrate sound hole portion provided on the first surface for causing the hollow portion and the vibrating portion to communicate with each other, a second substrate sound hole portion provided on the first surface for causing the hollow portion and the exterior to communicate with each other, and a coating liquid draining hole portion provided on the second surface for causing the hollow portion and the exterior to communicate with each other, and the coating liquid draining hole portion is sealed.

In the substrate for a microphone unit according to the fourth aspect of the present invention, as hereinabove described, the coating layer formed on the inner surface of the hollow portion of the substrate is so provided that the hollow portion is coated with the coating layer, whereby the hollow portion can be inhibited from collecting dust such as chips. Further, the coating liquid draining hole portion causing the hollow portion and the exterior to communicate with each other is so provided that a coating liquid employed for forming the coating layer can be easily drained through the coating liquid draining hole portion, whereby the hollow portion can be inhibited from collecting dust such as a residue of the coating liquid. In addition, external sound penetration as well as external dust penetration can be prevented by sealing the coating liquid draining hole portion. Thus, dust can be inhibited from entering the vibrating portion communicating with the hollow portion. Further, the first and second substrate sound hole portions are provided on the first surface while the coating liquid draining hole portion is provided on the second surface opposite to the first surface so that the first and second substrate sound hole portions and the coating liquid draining hole portion are arranged on the sides of the hollow portion opposite to each other, whereby the coating liquid employed for forming the coating layer can be easily drained through the coating liquid draining hole portion along the first and second substrate sound hole portions serving as air holes.

In the aforementioned substrate for a microphone unit according to the fourth aspect, the substrate preferably includes a first substrate layer, a second substrate layer and a third substrate layer arranged on a side of the second substrate layer opposite to the first substrate layer, the first substrate sound hole portion and the second substrate sound hole portion are preferably formed on the first substrate layer, the hollow portion is preferably formed on the second substrate layer, the coating liquid draining hole portion is preferably formed on the third substrate layer, and the coating liquid draining hole portion is preferably sealed from the side of the second surface arranged on the side of the third substrate layer opposite to the second substrate layer. According to this structure, the substrate having the first and second substrate sound hole portions, the hollow portion and the coating liquid draining hole portion can be easily formed by stacking the first, second and third substrate layers individually provided with the first and second substrate sound hole portions, the hollow portion and the coating liquid draining hole portion.

In the aforementioned substrate for a microphone unit according to the fourth aspect, the coating liquid draining hole portion is preferably arranged between an end portion of the first substrate sound hole portion opposite to the second substrate sound hole portion and an end portion of the second substrate sound hole portion opposite to the first substrate sound hole portion in plan view. According to this structure, the coating liquid draining hole portion communicating with the hollow portion can be formed on a position between the first and second substrate sound hole portions, whereby the coating liquid employed for forming the coating layer on the hollow portion can be excellently drained. Thus, the coating layer can be uniformly formed.

A method of manufacturing a substrate for a microphone unit according to a fifth aspect of the present invention includes steps of forming a hollow portion transmitting a sound in a substrate having a first surface where a vibrating portion converting a sound to an electric signal is set and a second surface opposite to the first surface, forming a first substrate sound hole portion causing the hollow portion and the vibrating portion to communicate with each other on the first surface of the substrate, forming a second substrate sound hole portion causing the hollow portion and the exterior to communicate with each other on the first surface of the substrate, forming a coating liquid draining hole portion causing the hollow portion and the exterior to communicate with each other on the second surface, forming a coating layer on an inner surface of the hollow portion of the substrate, and sealing the coating liquid draining hole portion after the formation of the coating layer.

In the method of manufacturing a substrate for a microphone unit according to the fifth aspect of the present invention, as hereinabove described, the step of forming the coating layer on the inner surface of the hollow portion of the substrate is so provided that the hollow portion is coated with the coating layer, whereby the hollow portion can be inhibited from collecting dust such as chips. Further, the step of forming the coating liquid draining hole portion causing the hollow portion and the exterior to communicate with each other is so provided that a coating liquid employed for forming the coating layer can be easily drained through the coating liquid draining hole portion, whereby the hollow portion can be inhibited from collecting dust such as a residue of the coating liquid. In addition, the step of sealing the coating liquid draining hole portion is so provided that external sound penetration as well as external dust penetration can be prevented. Thus, a substrate for a microphone unit capable of inhibiting dust from entering the vibrating portion communicating with the hollow portion can be easily manufactured. Further, the first and second substrate sound hole portions are provided on the first surface while the coating liquid draining hole portion is provided on the second surface opposite to the first surface so that the first and second substrate sound hole portions and the coating liquid draining hole portion are arranged on the sides of the hollow portion opposite to each other, whereby the coating liquid employed for forming the coating layer can be easily drained through the coating liquid draining hole portion along the first and second substrate sound hole portions serving as air holes.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view showing the overall structure of a portable telephone according to a first embodiment of the present invention;

FIG. 2 is an overall perspective view of an MEMS microphone according to the first embodiment of the present invention as viewed from above;

FIG. 3 is an overall perspective view of the MEMS microphone according to the first embodiment of the present invention as viewed from below;

FIG. 4 is an exploded perspective view sowing the overall structure of the MEMS microphone according to the first embodiment of the present invention;

FIG. 5 is a perspective view of a substrate of the MEMS microphone according to the first embodiment of the present invention;

FIG. 6 is a sectional view of the MEMS microphone according to the first embodiment of the present invention taken along the line 200-200 in FIG. 2;

FIG. 7 is a plan view showing a first substrate layer of the MEMS microphone according to the first embodiment of the present invention;

FIG. 8 is a plan view showing a second substrate layer of the MEMS microphone according to the first embodiment of the present invention;

FIG. 9 is a plan view showing a third substrate layer of the MEMS microphone according to the first embodiment of the present invention;

FIG. 10 is a sectional view for illustrating a method of manufacturing the MEMS microphone according to the first embodiment of the present invention;

FIG. 11 is a sectional view for illustrating a bonding step in the method of manufacturing the MEMS microphone according to the first embodiment of the present invention;

FIG. 12 is a sectional view for illustrating a plating step in the method of manufacturing the MEMS microphone according to the first embodiment of the present invention;

FIG. 13 is a sectional view for illustrating an intermediate process in a sealing step in the method of manufacturing the MEMS microphone according to the first embodiment of the present invention;

FIG. 14 is a sectional view for illustrating the sealing step in the method of manufacturing the MEMS microphone according to the first embodiment of the present invention;

FIG. 15 is a diagram for illustrating screen printing in the sealing step in the method of manufacturing the MEMS microphone according to the first embodiment of the present invention;

FIG. 16 is a sectional view for illustrating a packaging step in the method of manufacturing the MEMS microphone according to the first embodiment of the present invention;

FIG. 17 is a sectional view of an MEMS microphone according to a second embodiment of the present invention taken along the line 200-200 in FIG. 2;

FIG. 18 is an enlarged sectional view of a sealed plating liquid draining hole portion shown in FIG. 17;

FIG. 19 is a sectional view of an MEMS microphone according to a third embodiment of the present invention taken along the line 200-200 in FIG. 2;

FIG. 20 is a sectional view of an MEMS microphone according to a fourth embodiment of the present invention taken along the line 200-200 in FIG. 2;

FIG. 21 is a bottom plan view showing the MEMS microphone according to the fourth embodiment of the present invention;

FIG. 22 is a plan view showing part of a packaging substrate for a portable telephone according to the fourth embodiment of the present invention;

FIG. 23 is a sectional view of an MEMS microphone according to a first modification of each of the first to fourth embodiments of the present invention; and

FIG. 24 is a sectional view of an MEMS microphone according to a second modification of each of the first to fourth embodiments of the present invention.

### DESCRIPTION OF THE PREFERRED EMBODIMENTS

Embodiments of the present invention are now described with reference to the drawings.

### First Embodiment

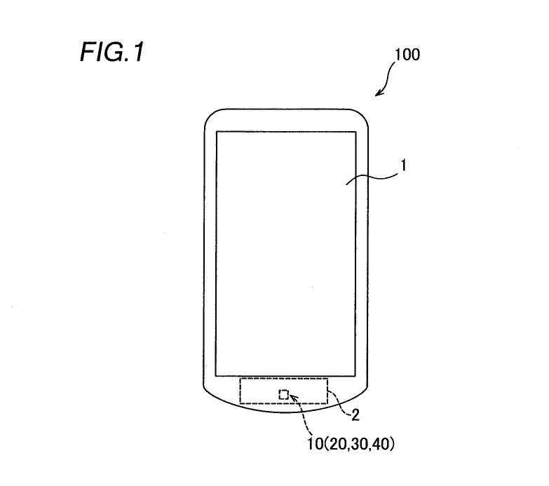

First, the structure of a portable telephone 100 according to a first embodiment of the present invention is described with reference to FIG. 1. The portable telephone 100 is an example of the “electronic apparatus” in the present invention.

The portable telephone 100 according to the first embodiment of the present invention has a substantially rectangular shape as viewed from front, as shown in FIG. 1. The portable telephone 100 includes a display portion 1. A packaging substrate 2 packaged with an MEMS (Micro Electro Mechanical Systems) microphone 10 is provided in a housing of the portable telephone 100. The MEMS microphone 10 is an example of the “microphone unit” in the present invention.

The structure of the MEMS microphone 10 according to the first embodiment of the present invention is described with reference to FIGS. 1 to 9.

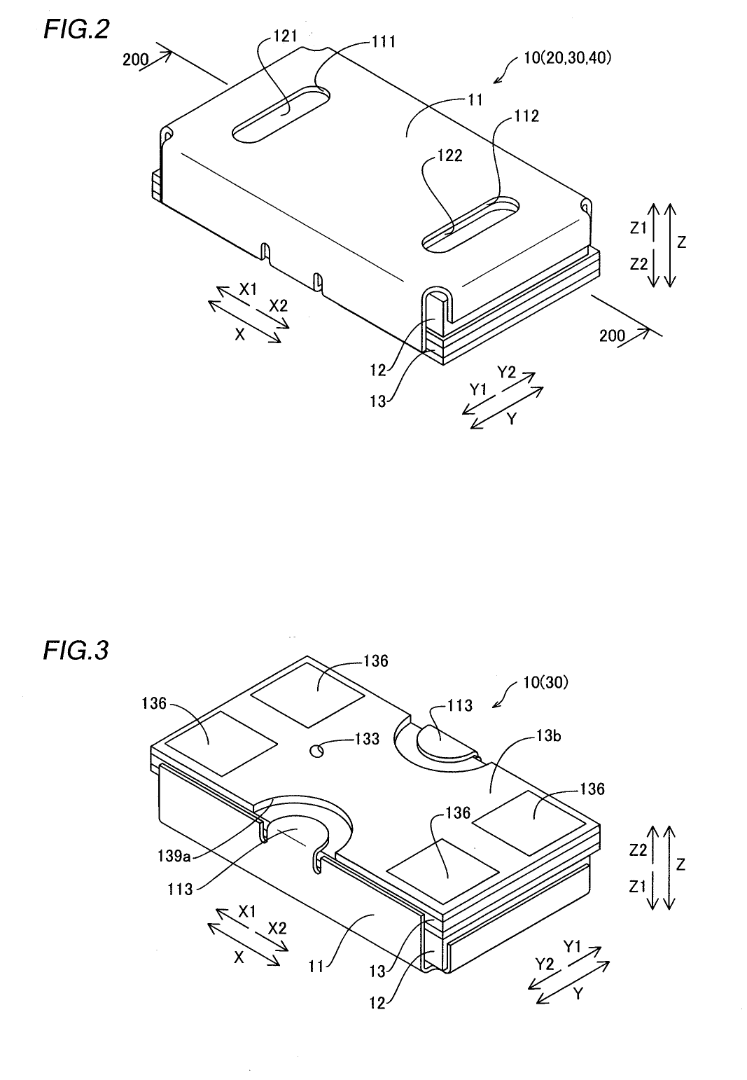

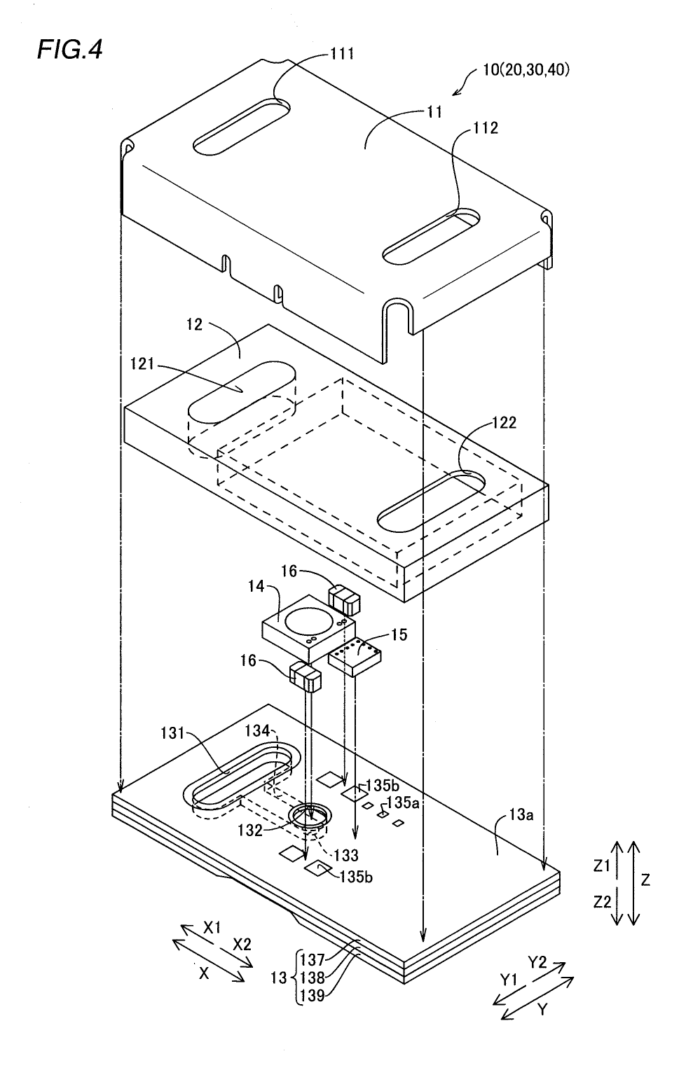

The MEMS microphone 10 is packaged on the packaging substrate 2, as shown in FIG. 1. Further, the MEMS microphone 10 includes a shield 11, a cover 12, a microphone substrate 13, a vibrating portion 14 (see FIG. 4), a circuit portion 15 (see FIG. 4) and a chip capacitor 16 (see FIG. 4), as shown in FIGS. 2 to 4. The microphone substrate 13 is an example of the “substrate” in the present invention.

The shield 11 is made of metal (nickel silver, for example), and provided for preventing electrical noise. Further, the shield 11 includes sound holes 111 and 112, as shown in FIG. 2. In addition, the shield 11 includes holding portions 113, as shown in FIG. 3. The sound holes 111 and 112 are arranged along arrow Z1, and elliptically formed. In other words, the MEMS microphone 10 is so formed that sounds enter the MEMS microphone 10 from the side (along arrow Z1) where the sound holes 111 and 112 are arranged. The holding portions 113 are arranged on the side (along arrow Z2) of the microphone substrate 13, and so caulked as to hold the microphone substrate 13.

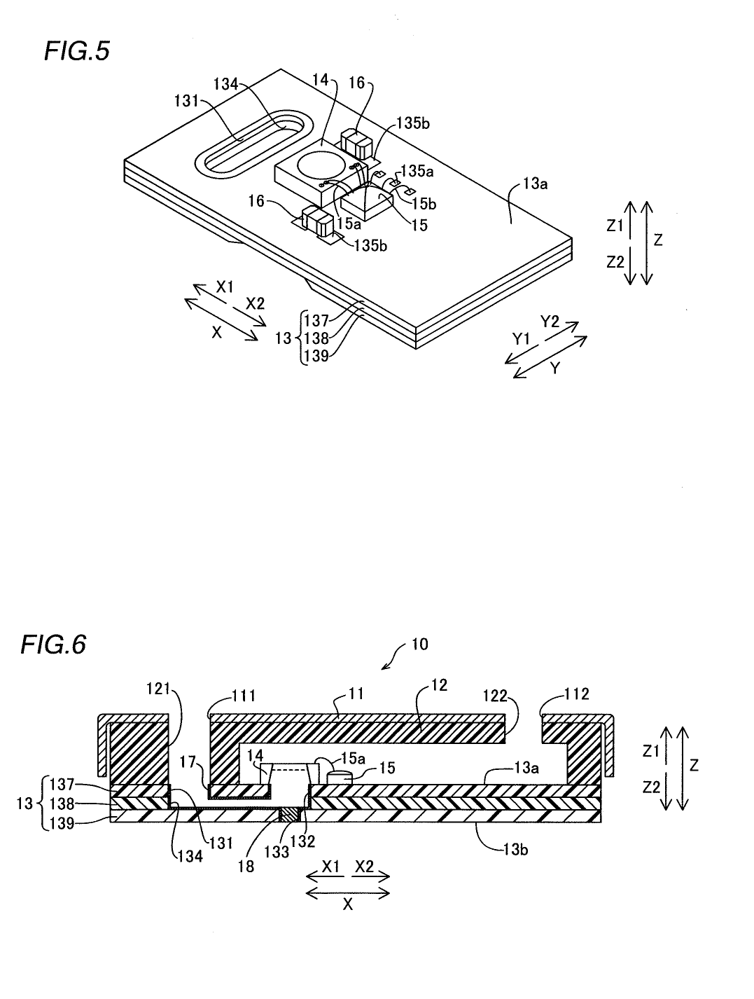

The cover 12 is made of glass epoxy resin. Further, the cover 12 is arranged between the shield 11 and the microphone substrate 13, as shown in FIG. 4. The cover 12 includes sound holes 121 and 122. The sound hole 121 partially forms a path of sounds entering the vibrating portion 14 from the side (along arrow Z2) of the microphone substrate 13, as shown in FIG. 6. The sound hole 122 partially forms a path of sounds entering the vibrating portion 14 from the side (along arrow Z1) of the cover 12. The sound holes 121 and 122 are elliptically formed.

The microphone substrate 13 includes substrate sound hole portions 131 and 132, a plating solution draining hole portion 133, a hollow portion 134, bonding pads 135a, pads 135b and electrode pads 136 (see FIG. 3), as shown in FIG. 4. Further, the microphone substrate 13 has a three-layer structure of first, second ad third substrate layers 137, 138 and 139, as shown in FIG. 6. The substrate sound hole portions 131 and 132, the plating solution draining hole portion 133 and the hollow portion 134 are formed by cutting the first, second and third substrate layers 137, 138 and 139 with a drill or a router or by NC (numerical control). Therefore, dust may result from cut surfaces. The substrate sound hole portions 131 and 132 are examples of the “second substrate sound hole portion” and the “first substrate sound hole portion” in the present invention respectively. The plating solution draining hole portion 133 is an example of the “coating liquid draining hole portion” in the present invention.

Plating layers 17 of copper are formed on inner surfaces of the substrate sound hole portions 131 and 132, the plating liquid draining hole portion 133 and the hollow portion 134, to cover the cut surfaces. The first substrate layer 137 is arranged on a side (along arrow Z1) of the second substrate layer 138 closer to the cover 12. The third substrate layer 139 is arranged on a side (along arrow Z2) of the second substrate 138 opposite to the first substrate layer 137. The microphone substrate 13 and the plating layers 17 mainly constitute a substrate for a microphone unit. The plating layers 17 are examples of the “coating layer” in the present invention.

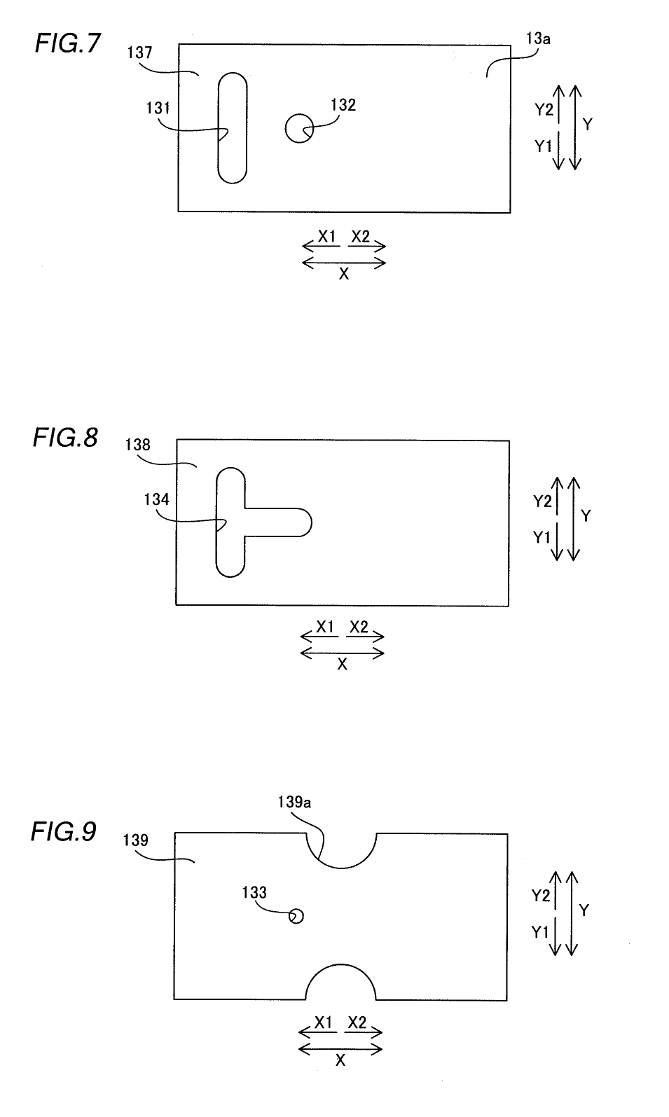

The substrate sound hole portion 131 is so formed that sounds externally enter the same through the sound holes 111 and 121 of the shield 11 and the cover 12, as shown in FIG. 6. This substrate sound hole portion 131 is formed to cause the hollow portion 134 and the exterior (outer surface of the first substrate layer 137) receiving the sounds to communicate with each other. Further, the substrate sound hole portion 131 is formed on the first substrate layer 137, as shown in FIG. 7. In addition, the substrate sound hole portion 131 is elliptically formed on a surface (upper surface) 13a of the microphone substrate 13 (first substrate layer 137) along arrow Z1. The upper surface 13a of the microphone substrate 13 is an example of the “first surface” in the present invention.

The substrate sound hole portion 132 is arranged on a side of the substrate sound hole portion 131 along arrow X2, as shown in FIG. 6. This substrate sound hole portion 132 is so formed that sounds externally enter the same through the substrate sound hole portion 131 and the hollow portion 134. The substrate sound hole portion 132 is formed to cause the hollow portion 134 and the vibrating portion 14 to communicate with each other. In other words, a side of the substrate sound hole portion 132 along arrow Z1 is covered with the vibrating portion 14. Further, the substrate sound hole portion 132 is formed on the first substrate layer 137, as shown in FIG. 7. In addition, the substrate sound hole portion 132 is formed on the upper surface 13a of the microphone substrate 13 (first substrate layer 137) in the form of a circle (circle of 0.6 mm in diameter, for example).

The plating liquid draining hole portion 133 is formed to cause the exterior on the side (along arrow Z2) of a surface (lower surface) 13b of the microphone substrate 13 opposite to the upper surface 13a and the hollow portion 134 to communicate with each other. The plating liquid draining hole portion 133 is formed on the third substrate layer 139, as shown in FIG. 9. The plating liquid draining hole portion 133 is formed on the lower surface 13b of the microphone substrate 13 (third substrate layer 139) in the form of a circle (circle of 0.3 mm in diameter, for example). Further, the plating liquid draining hole portion 133 is arranged concentrically with the substrate sound hole portion 132 in plan view (as viewed from a direction Z), as shown in FIG. 4. In addition, the plating liquid draining hole portion 133 is arranged immediately under the substrate sound hole portion 132 (along arrow Z2). In other words, the plating liquid draining hole portion 133 is arranged on a position overlapping with the substrate sound hole portion 132. The plating liquid draining hole portion 133 is arranged between an end portion of the substrate sound hole portion 131 along arrow X1 and an end portion of the substrate sound hole portion 132 along arrow X2 in plan view (as viewed from the direction Z), as shown in FIG. 6. Preferably, the plating liquid draining hole portion 133 is smaller in diameter than the substrate sound hole portion 132 (131) and arranged immediately under the substrate sound hole portion 132 (131) for a reason described later. The lower surface 13b of the microphone substrate 13 is an example of the “second surface” in the present invention.

According to the first embodiment, a resin member 18 is charged into the plating liquid draining hole portion 133, as shown in FIG. 6. The resin member 18 is made of epoxy resin, acrylic resin, thermosetting ink, ultraviolet curing ink, heat and ultraviolet curing ink, photosensitive solder resist or the like, for example. The plating liquid draining hole portion 133 is sealed with the resin member 18 from the side (along arrow Z2) of the lower surface 13b of the microphone substrate 13. Thus, sounds can be inhibited from entering the plating liquid draining sound hole 133 or leaking out of the same. The resin member 18 is charged up to a portion close to the boundary between the plating liquid draining hole portion 133 and the side (along arrow Z1) of the hollow portion 134. In other words, a surface of the resin member 18 on the side (along arrow Z1) of the hollow portion 134 is arranged on a position where the same is substantially flush with the inner surface of the hollow portion 134. The resin member 18 is an example of the “sealing member” or the “sealing material” in the present invention.

The hollow portion 134 is provided for transmitting sounds in the microphone substrate 13. In other words, the portable telephone 100 is so formed that sounds entering the substrate sound hole portion 131 of the microphone substrate 13 along arrow Z2 through the sound holes 111 and 121 of the shield 11 and the cover 12 are transmitted to the vibrating portion 14 through the hollow portion 134 and the substrate sound hole portion 132. The hollow portion 134 is formed on the intermediate second substrate layer 138, as shown in FIG. 6. Further, the hollow portion 134 is in the form of a “T” extending in directions X and Y in plan view, as shown in FIG. 8.

The bonding pads 135a are provided for connecting the microphone substrate 13 and the circuit portion 15 with each other through bonding wires 15b, as shown in FIG. 5. The pads 135b are provided for connecting the microphone 13 and the chip capacitor 16 with each other by solder. The bonding pads 135a and the pads 135b are arranged on the upper surface 13a of the microphone substrate 13. Further, the bonding pads 135a and the pads 135b are connected to the electrode pads 136 (see FIG. 3) arranged on the lower surface 13b of the microphone substrate 13 through unshown circuit patterns and unshown through-holes respectively. The MEMS microphone 10 is packaged on the packaging substrate 2 (see FIG. 1) by soldering through the electrode pads 136.

The first, second and third substrate layers 137, 138 and 139 are made of glass epoxy resin. Further, the first, second and third substrate layers 137, 138 and 139 are bonded to each other through unshown bonding sheets.

The vibrating portion 14 is arranged on the upper surface 13a of the microphone substrate 13 to cover the substrate sound hole portion 132, as shown in FIGS. 4 and 5. The vibrating portion 14 is formed to convert sounds to electric signals by detecting change in capacitance of a capacitor formed by a diaphragm and a back plate electrode. Further, the vibrating portion 14 is bonded to the upper surface 13a of the microphone substrate 13 by an unshown bonding layer. In addition, the vibrating portion 14 is connected to the circuit portion 15 by bonding wires 15a (made of gold, for example), as shown in FIG. 5.

The circuit portion 15 is arranged on the upper surface 13a of the microphone substrate 13, as shown in FIG. 5. The circuit portion 15 is formed to process the electric signals output from the vibrating portion 14. Further, the circuit portion 15 is bonded to the upper surface 13a of the microphone substrate 13 by an unshown bonding layer. In addition, the circuit portion 15 is connected to the bonding pads 135a by the bonding wires 15b (made of gold, for example).

The chip capacitor 16 is arranged on the upper surface 13a of the microphone substrate 13, as shown in FIG. 5. The chip capacitor 16 is soldered to the pads 135b, to be packaged on the microphone substrate 13.

According to the first embodiment, as hereinabove described, the plating layer 17 formed on the inner surface of the hollow portion 134 of the microphone substrate 13 is so provided that the hollow portion 134 is coated with the plating layer 17, whereby dust emission from the cut surface of the hollow portion 134 can be suppressed. Further, the plating liquid draining hole portion 133 causing the hollow portion 134 and the exterior to communicate with each other is so provided that an electroless copper plating liquid and a copper sulfate electroplating liquid employed for forming the plating layer 17 can be easily drained through the plating liquid draining hole portion 133, whereby the hollow portion 134 can be inhibited from collecting dust such as residues of the electroless copper plating liquid and the copper sulfate electroplating liquid. In addition, external sound penetration as well as external dust penetration can be prevented by sealing the plating liquid draining hole portion 133. Thus, dust can be inhibited from entering the vibrating portion 14 communicating with the hollow portion 134. The substrate sound hole portions 131 and 132 are provided on the upper surface 13a of the microphone substrate 13 while the plating liquid draining hole portion 133 is provided on the lower surface 13b of the microphone substrate 13 so that the substrate sound hole portions 131 and 132 and the plating liquid draining hole portion 133 are arranged on the sides of the hollow portion 134 opposite to each other, whereby the electroless copper plating liquid and the copper sulfate electroplating liquid employed for forming the plating layer 17 can be easily drained through the plating liquid draining hole portion 133 along the substrate sound hole portions 131 and 132 serving as air holes.

According to the first embodiment, the third substrate layer 139 is arranged on the side of the second substrate layer 138 opposite to the first substrate layer 137 while the substrate sound hole portions 131 and 132 are formed on the first substrate layer 137, the hollow portion 134 is formed on the second substrate layer 138, the plating liquid draining hole portion 133 is formed on the third substrate layer 139 and the plating liquid draining hole portion 133 is sealed from the side (along arrow Z2) of the third substrate layer 139 closer to the lower surface 13b, whereby the microphone substrate 13 having the substrate sound hole portions 131 and 132, the hollow portion 134 and the plating liquid draining hole portion 133 can be easily formed by stacking the first, second and third substrate layers 137, 138 and 139 individually provided with the substrate sound hole portions 131 and 132, the hollow portion 134 and the plating liquid draining hole portion 133.

According to the first embodiment, the plating liquid draining hole portion 133 is arranged between the end portion of the substrate sound hole portion 131 along arrow X1 and the end portion of the substrate sound hole portion 132 along arrow X2 in plan view so that the plating liquid draining hole portion 133 communicating with the hollow portion 134 can be formed on the position between the substrate sound hole portions 131 and 132, whereby the electroless copper plating liquid and the copper sulfate electroplating liquid employed for forming the plating layer 17 on the hollow portion 134 can be excellently drained. Thus, the plating layer 17 can be uniformly formed.

According to the first embodiment, the plating liquid draining hole portion 133 is sealed with the resin member 18 different from the microphone substrate 13 so that the plating liquid draining hole portion 133 can be easily sealed with the resin member 18 different from the microphone substrate 13, whereby dust can be easily prevented from penetrating the hollow portion 134 through the plating liquid draining hole portion 133.

According to the first embodiment, the resin member 18 is charged up to a portion close to the boundary between the plating liquid draining hole portion 133 and the side (along arrow Z1) of the hollow portion 134 so that irregularities of the hollow portion 134, serving as a sound transmission path, around the plating liquid draining hole portion 133 can be so reduced that the hollow portion 134 can smoothly transmit sounds.

A method of manufacturing the MEMS microphone 10 according to the first embodiment of the present invention is now described with reference to FIGS. 7 to 16.

In the method of manufacturing the MEMS microphone 10, a plurality of MEMS microphones 10 are simultaneously manufactured on one substrate material. The method of manufacturing the MEMS microphone 10 includes a step of forming the first substrate layer 137, a step of forming the second substrate layer 138, a step of forming the third substrate layer 139, a bonding step, a plating step, a sealing step, a packaging step and a cutting step. The circuit patterns (not shown), the through-holes (not shown), the bonding pads 135a, the pads 135b and the electrode pads 136 are properly formed before or after the aforementioned steps or between the steps.

In the step of forming the first substrate layer 137, the first substrate layer 137 is formed by forming the substrate sound hole portions 131 and 132 on a glass epoxy substrate by cutting or the like with a drill or a router or by NC (numerical control), as shown in FIG. 7. In the step of forming the second substrate layer 138, the second substrate layer 138 is formed by forming the hollow portion 134 on the glass epoxy substrate by cutting or the like with a drill or a router or by NC, as shown in FIG. 8. In the step of forming the third substrate layer 139, the third substrate layer 139 is formed by forming the plating liquid draining hole portion 133 and notches 139a on the glass epoxy substrate by cutting or the like with a drill or a router or by NC, as shown in FIG. 9.

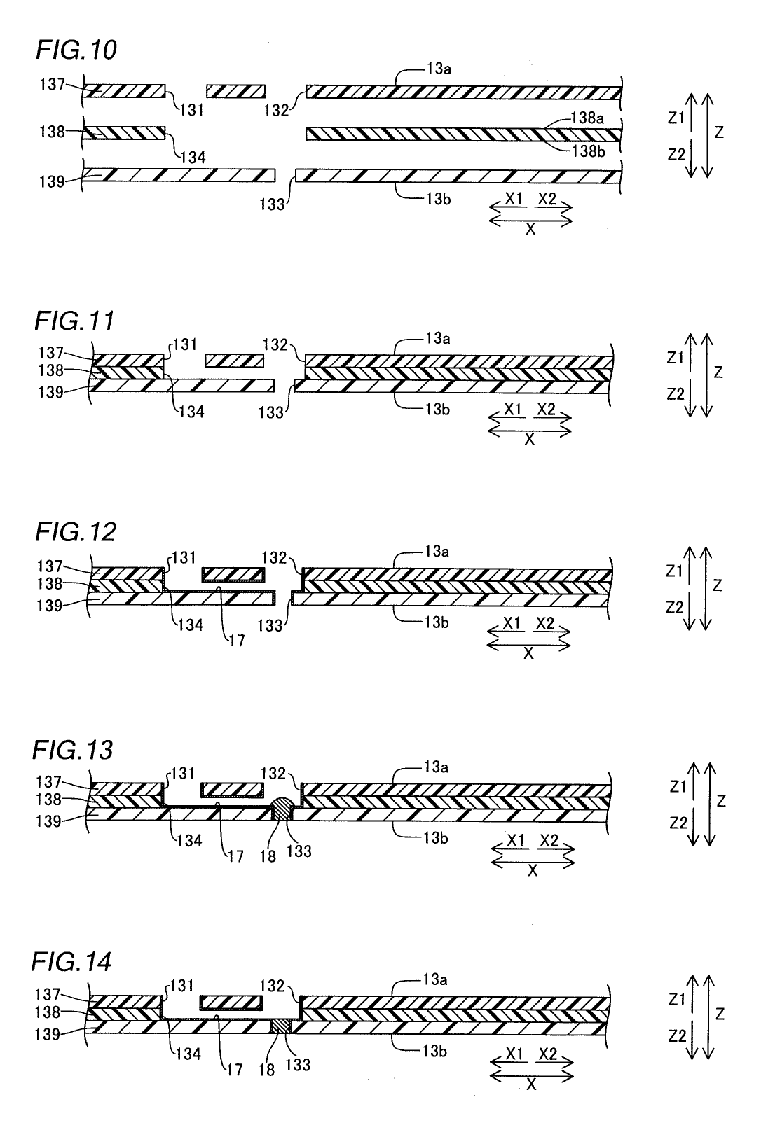

In the bonding step, the second substrate layer 138 and the first and third substrate layers 137 and 139 are bonded to each other through unshown bonding sheets stuck to surfaces (upper ad lower surfaces) 138a and 138b (see FIG. 10) of the second substrate layer 138 along arrows Z1 and Z2 respectively, as shown in FIG. 11.

In the plating step, the plating layers 17 of copper are formed on the inner surfaces of the substrate sound hole portions 131 and 132, the plating liquid draining hole portion 133 and the hollow portion 134, as shown in FIG. 12. More specifically, the upper and lower surfaces 13a and 13b of the microphone substrate 13 provided with no plating layers 17 are subjected to resist treatment, and the inner surfaces of the substrate sound hole portions 131 and 132, the plating liquid draining hole portion 133 and the hollow portion 134 to be provided with the plating layers 17 are thereafter treated with a catalyst (palladium or the like, for example). Thereafter the first, second and third substrate layers 137, 138 and 139 are dipped in the electroless copper plating liquid, to deposit copper on the inner surfaces of the substrate sound hole portions 131 and 132, the plating liquid draining hole portion 133 and the hollow portion 134 with a thickness of at least 0.01 μm and not more than 3 μm, for example. After the electroless copper plating liquid is drained through the plating liquid draining hole portion 133, the first, second and third substrate layers 137, 138 and 139 are dipped in the copper sulfate electroplating liquid and energized, thereby depositing copper on the inner surfaces of the substrate sound hole portions 131 and 132, the plating liquid draining hole portion 133 and the hollow portion 134 with a thickness of at least 2 μm and not more than 50 μm, for example, and forming the plating layers 17. Then, the copper sulfate electroplating liquid is drained through the plating liquid draining hole portion 133.

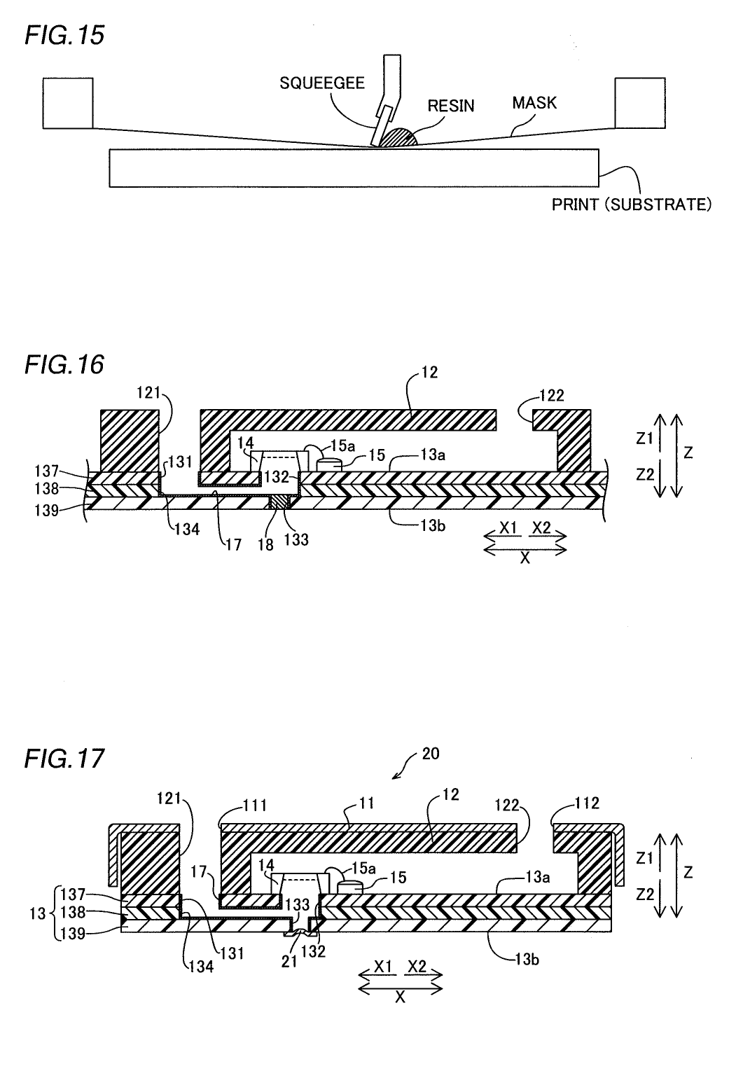

In the sealing step, the plating liquid draining hole portion 133 is sealed by charging the resin member 18 thereinto, as shown in FIG. 14. More specifically, the resin member 18 is charged into the plating liquid draining hole portion 133 from the side (along arrow Z2) of the lower surface 13b of the microphone substrate 13 by screen printing (see FIG. 15). The screen printing is performed by employing a screen of Tetron (registered trademark) or stainless steel having at least 50 meshes/in. and not more than 300 meshes/in. and a flat or blade squeegee having Shore hardness of at least 50 HS and not more than 80 HS, for example. As shown in FIG. 13, the resin member 18 swells toward the side (along arrow Z1) of the substrate sound hole portion 132 immediately after the screen printing. Thereafter the surface (along arrow Z1) of the resin member 18 closer to the substrate sound hole portion 132 becomes substantially flush with the inner surface of the hollow portion 134 due to viscosity. If the plating liquid draining hole portion 133 is larger in diameter than the substrate sound hole portion 132 (131) or not present immediately under the substrate sound hole portion 132 (131), the resin member 18 may be drawn into the substrate sound hole portion 132 or the hollow portion 134 by coming into contact with the first substrate layer 137 to block the sound transmission path when swelling toward the side (along arrow Z1) of the first substrate layer 137 immediately after the screen printing. In order to prevent such blocking of the sound transmission path, the plating liquid draining hole portion 133 is preferably smaller in diameter than the substrate sound hole portion 132 (131) and arranged immediately under the substrate sound hole portion 132 (131).

In the packaging step, the vibrating portion 14, the circuit portion 15, the chip capacitor 16 (see FIG. 5) and the cover 12 are packaged on the upper surface 13a of the microphone substrate 13, as shown in FIG. 16. Thereafter the plurality of MEMS microphones 10 arranged in the directions X and Y are individually cut in the cutting step. Thereafter the MEMS microphone 10 according to the first embodiment is completed by setting the shield 11 on the cover 12.

According to the first embodiment, the step of forming the plating layer 17 on the inner surface of the hollow portion 134 of the microphone substrate 13 is so provided that the hollow portion 134 is coated with the plating layer 17, whereby dust emission from the cut surface of the hollow portion 134 can be suppressed. Further, the step of forming the plating liquid draining hole portion 133 causing the hollow portion 134 and the exterior to communicate with each other is so provided that the electroless copper plating liquid and the copper sulfate electroplating liquid employed for forming the plating layer 17 can be easily drained through the plating liquid draining hole portion 133, whereby the hollow portion 134 can be inhibited from collecting dust such as residues of the electroless copper plating liquid and the copper sulfate electroplating liquid. In addition, the sealing step for the plating liquid draining hole portion 133 is so provided that external sound penetration as well as external dust penetration can be prevented. Thus, the MEMS microphone 10 capable of inhibiting dust from entering the vibrating portion 14 communicating with the hollow portion 134 can be easily manufactured.

### Second Embodiment

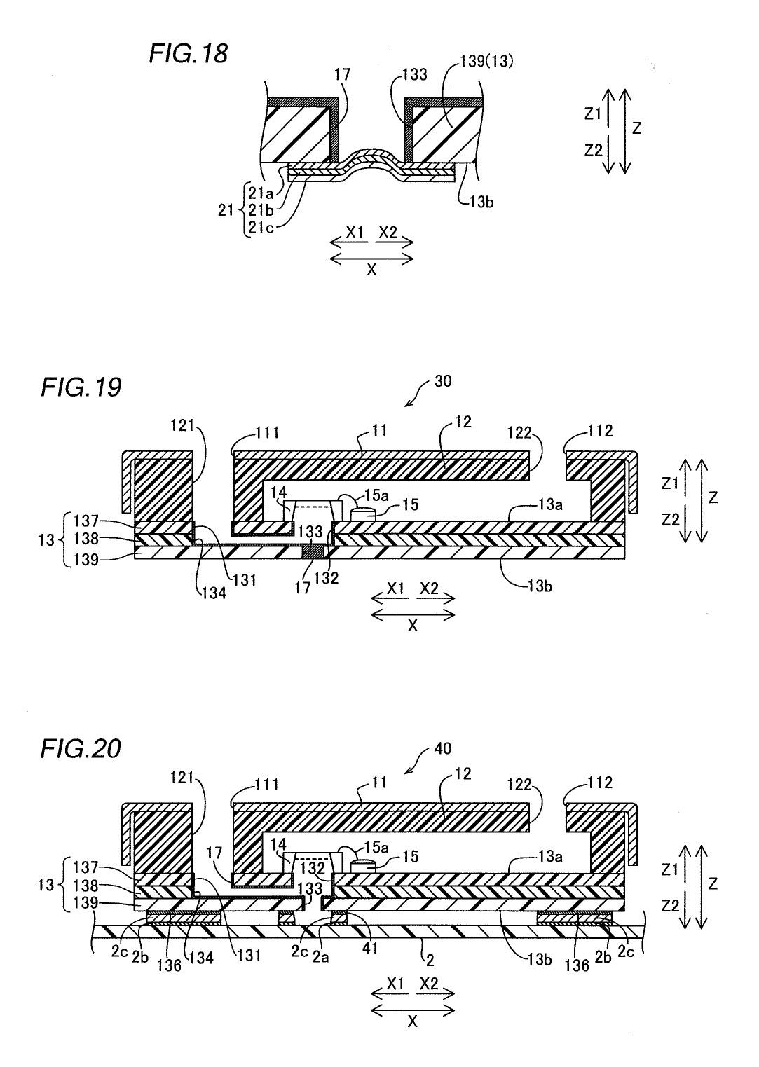

An MEMS microphone 20 of a portable telephone 100 according to a second embodiment of the present invention is now described with reference to FIGS. 17 and 18. According to the second embodiment, a plating liquid draining hole portion 133 of the MEMS microphone 20 is covered and sealed with a dry film resist 21, dissimilarly to the aforementioned first embodiment.

In the MEMS microphone 20 of the portable telephone 100 according to the second embodiment, the plating liquid draining hole portion 133 is sealed by being covered with the dry film resist 21, as shown in FIG. 17. Further, the plating liquid draining hole portion 133 is sealed with the dry film resist 21 from a side (along arrow Z2) of a lower surface 13b of a microphone substrate 13. The dry film resist 21 is stuck to the lower surface 13b of the microphone substrate 13. Further, the dry film resist 21 includes a first photoresist layer 21a, a second photoresist layer 21b and a support 21c successively from the side of the lower surface 13b of the microphone substrate 13, as shown in FIG. 18. In addition, the dry film resist 21 is stuck to the lower surface 13b of the microphone substrate 13 by heating, and hardened by exposure. The first photoresist layer 21a exhibits larger fluidity than the second photoresist layer 21b when heated. Thus, the dry film resist 21 is so stuck to the lower surface 13a of the microphone substrate 13 that a portion around the center of the plating liquid draining hole portion 133 swells toward a hollow portion side (along arrow Z2). Consequently, adhesiveness between the dry film resist 21 and the microphone substrate 13 can be increased, whereby the dry film resist 21 can more reliably seal the plating liquid draining hole portion 133. The dry film resist 21 is an example of the “sealing member” or the “sealing film” in the present invention.

The remaining structure of the second embodiment is similar to that of the aforementioned first embodiment.

Also according to the structure of the second embodiment, as hereinabove described, a plating layer 17 formed on an inner surface of a hollow portion 134 of the microphone substrate 13 and the plating liquid draining hole portion 133 causing the hollow portion 134 and the exterior to communicate with each other are provided and the plating liquid draining hole portion 133 is sealed similarly to the aforementioned first embodiment, whereby dust can be inhibited from entering a vibrating portion 14 communicating with the hollow portion 134.

According to the second embodiment, as hereinabove described, the plating liquid draining hole portion 133 is sealed by being covered with the dry film resist 21 stuck to the lower surface 13b of the microphone substrate 13, whereby the same can be easily sealed by sticking the dry film resist 21 to the lower surface 13b of the microphone substrate 13.

The remaining effects of the second embodiment are similar to those of the aforementioned first embodiment.

### Third Embodiment

An MEMS microphone 30 of a portable telephone 100 according to a third embodiment of the present invention is now described with reference to FIG. 19. According to the third embodiment, a plating liquid draining hole portion 133 of the MEMS microphone 30 is sealed with a plating layer 17, dissimilarly to the aforementioned first and second embodiments.

In the MEMS microphone 30 of the portable telephone 100 according to the third embodiment, the plating liquid draining hole portion 133 is sealed with the plating layer 17, as shown in FIG. 19. Further, the plating liquid draining hole portion 133 is sealed with the plating layer 17 from a side (along arrow Z2) of a lower surface 13b of a microphone substrate 13. In other words, the plating liquid draining hole portion 133 is sealed with the plating layer 17 by depositing copper to completely cover the plating liquid draining hole portion 133 when forming the plating layer 17 on an inner surface of the plating liquid draining hole portion 133. More specifically, copper is deposited on inner surfaces of substrate sound hole portions 131 and 132, the plating liquid draining hole portion 133 and a hollow portion 134, and a copper sulfate electroplating liquid is thereafter gradually drained from the plating liquid draining hole portion 133. Also after the copper sulfate electroplating liquid is drained from the substrate sound hole portions 131 and 132 and the hollow portion 134, copper is continuously deposited on the inner surface of the plating liquid draining hole portion 133 from the copper sulfate electroplating liquid in the plating liquid draining hole portion 133, to seal the plating liquid draining hole portion 133. Thus, the plating liquid draining hole portion 133 can be sealed without leaving the copper plating liquid in the hollow portion 134. The plating layer 17 is an example of the “sealing member” in the present invention.

The remaining structure of the third embodiment is similar to that of the aforementioned first embodiment.

Also according to the structure of the third embodiment, as hereinabove described, the plating layer 17 formed on the inner surface of the hollow portion 134 of the microphone substrate 13 and the plating liquid draining hole portion 133 causing the hollow portion 134 and the exterior to communicate with each other are provided and the plating liquid draining hole portion 133 is sealed, whereby dust can be inhibited from entering a vibrating portion 14 communicating with the hollow portion 134.

According to the third embodiment, as hereinabove described, the plating liquid draining hole portion 133 is sealed with the plating layer 17, whereby the plating liquid draining hole portion 133 can be easily sealed with the same plating layer 17 as plating layers 17 plating the inner surfaces of the substrate sound hole portions 131 and 132, the plating liquid draining hole portion 133 and the hollow portion 134.

The remaining effects of the third embodiment are similar to those of the aforementioned first embodiment.

### Fourth Embodiment

An MEMS microphone 40 of a portable telephone 100 according to a fourth embodiment of the present invention is now described with reference to FIGS. 20 to 22. According to the fourth embodiment, a plating liquid draining hole portion 133 of the MEMS microphone 40 is sealed with a packaging substrate 2 and a solder joint pad 41, dissimilarly to the aforementioned first to third embodiments.

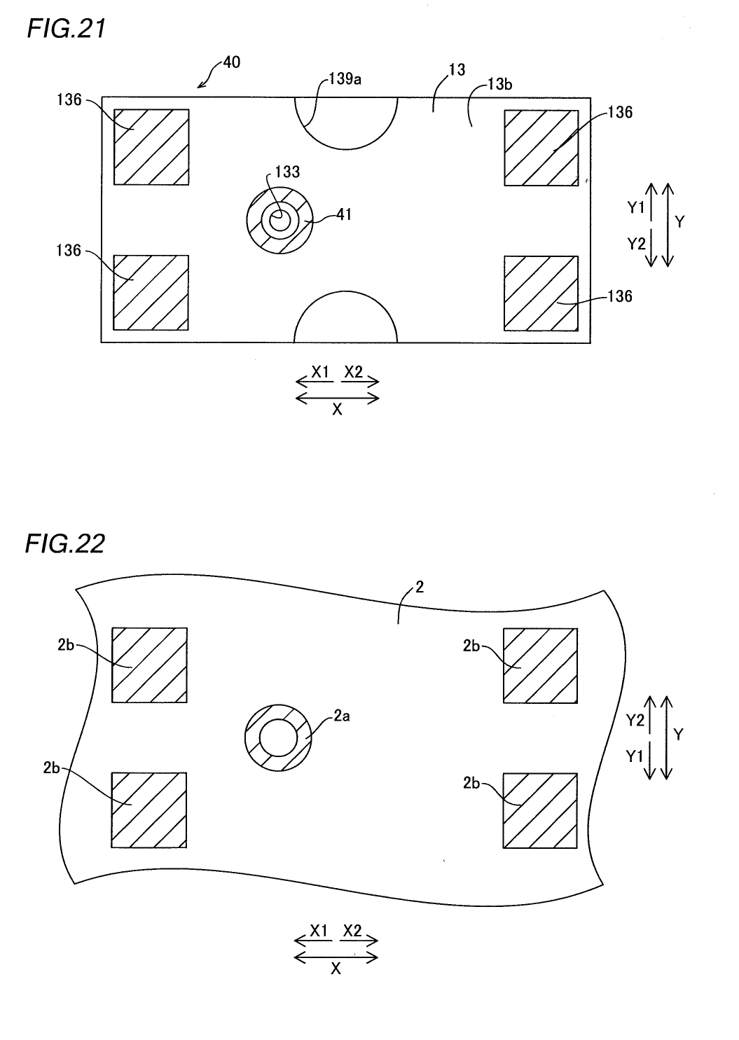

In the MEMS microphone 40 of the portable telephone 100 according to the fourth embodiment, the plating liquid draining hole portion 133 is sealed with the packaging substrate 2 and the solder joint pad 41, as shown in FIG. 20. Further, the plating liquid draining hole portion 133 is sealed with the packaging substrate 2 and the solder joint pad 41 from a side (along arrow Z2) of a lower surface 13b of a microphone substrate 13. More specifically, the solder joint pad 41 and a land 2a of the packaging substrate 2 are bonded to each other by solder 2c in the MEMS microphone 40. The solder joint pad 41 is annularly formed on the lower surface 13b of the microphone substrate 13 to surround the plating liquid draining hole portion 133, as shown in FIG. 21. The microphone substrate 13, a plating layer 17 and the solder joint pad 41 mainly constitute a substrate for a microphone unit. The land 2a is annularly formed on a position of the packaging substrate 2 corresponding to the solder joint pad 41, as shown in FIG. 22. Electrode pads 136 of the MEMS microphone 40 and lands 2b of the packaging substrate 2 are bonded to each other by solder 2c. Thus, the MEMS microphone 40 is packaged on the packaging substrate 2. The solder joint pad 41 is an example of the “sealing member” in the present invention.

The remaining structure of the fourth embodiment is similar to that of the aforementioned first embodiment.

Also according to the structure of the fourth embodiment, as hereinabove described, the plating layer 17 formed on an inner surface of a hollow portion 134 of the microphone substrate 13 and the plating liquid draining hole portion 133 causing the hollow portion 134 and the exterior to communicate with each other are provided and the plating liquid draining hole portion 133 is sealed similarly to the aforementioned first embodiment, whereby dust can be inhibited from entering a vibrating portion 14 communicating with the hollow portion 134.

According to the fourth embodiment, as hereinabove described, the solder joint pad 41 arranged on the region of the lower surface 13b of the microphone substrate 13 surrounding the plating liquid draining hole portion 133 is further provided and the plating liquid draining hole portion 133 is so formed that the solder joint pad 41 is soldered to the packaging substrate 2 packaged with the MEMS microphone 40 and the plating liquid draining hole portion 133 is sealed with the packaging substrate 2 and the solder joint pad 41 so that the plating liquid draining hole portion 133 is sealed with the packaging substrate 2 and the solder joint pad 41 at the same time when the MEMS microphone 40 is packaged on the packaging substrate 2, whereby no step for sealing the plating liquid draining hole portion 133 may be separately provided.

The remaining effects of the fourth embodiment are similar to those of the aforementioned first embodiment.

Although the present invention has been described and illustrated in detail, it is clearly understood that the same is by way of illustration and example only and is not to be taken by way of limitation, the spirit and scope of the present invention being limited only by the terms of the appended claims.

For example, while the present invention is applied to the portable telephone as an example of the electronic apparatus according to the present invention in each of the aforementioned first to fourth embodiments, the present invention is not restricted to this. The present invention may alternatively be applied to an electronic apparatus other than the portable telephone. For example, the present invention may be applied to an electronic apparatus, such as a digital camera, a video camera, a voice recorder, a portable information terminal or a PC (personal computer) packaged with a microphone unit.

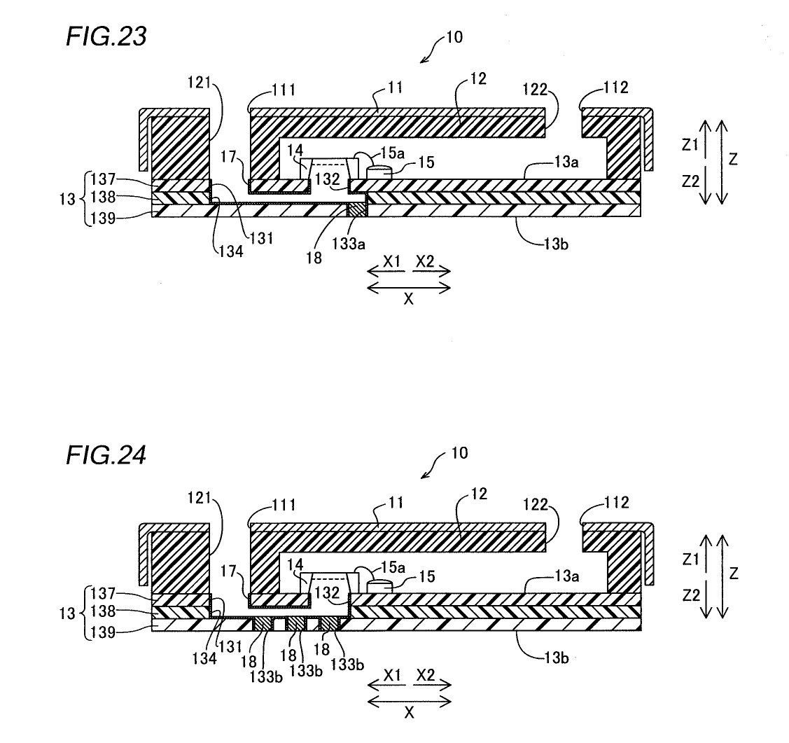

While the plating liquid draining hole portion is arranged between the end portion of the first substrate sound hole portion (substrate sound hole portion 132) opposite to the second substrate sound hole portion (substrate sound hole portion 131) and the end portion of the second substrate sound hole portion opposite to the first substrate sound hole portion in plan view as a coating liquid draining hole portion in each of the aforementioned first to fourth embodiments, the present invention is not restricted to this. According to the present invention, a coating liquid draining hole portion (plating liquid draining hole portion 133a) may alternatively be arranged on an outer side (along arrow X2) of a first substrate sound hole portion (substrate sound hole portion 132) opposite to a second substrate sound hole portion (substrate sound hole portion 131) in plan view (as viewed from a direction Z), as in a first modification shown in FIG. 23, for example. The coating liquid draining hole portion may further alternatively be arranged on an outer side (along arrow X1) of the second substrate sound hole opposite to the first substrate sound hole portion in plan view (as viewed from the direction Z). Thus, irregularities of a sound transmission path can be reduced by arranging the coating liquid draining hole portion (plating liquid draining hole portion 133a) on the outside of the sound transmission path, whereby sounds can be smoothly transmitted.

While one plating liquid draining hole portion serving as the coating liquid draining hole portion is circularly formed in each of the aforementioned first to fourth embodiments, the present invention is not restricted to this. According to the present invention, a plurality of coating liquid draining hole portions (plating liquid draining hole portions 133b) may alternatively be formed, as in a second modification shown in FIG. 24, for example. Further, the coating liquid draining hole portion may not be circularly formed. For example, the coating liquid draining hole portion may be elliptically, oblongly or rectangularly formed.

While the plating layers as examples of the coating layer are formed by performing electroless copper plating and thereafter performing copper electroplating in each of the aforementioned first to fourth embodiments, the present invention is not restricted to this. According to the present invention, the plating layers may alternatively be formed by performing only electroless copper plating. Further, the coating layer may be formed by plating of metal other than copper. For example, the coating layer may be formed by plating of metal such as nickel, gold, silver, tin, palladium or a combination thereof. In addition, the coating layer may be formed by a coating layer made of metal other than plating metal or a material other than metal.

While two substrate sound hole portions are provided and one vibrating portion is packaged on the microphone substrate serving as the substrate in each of the aforementioned first to fourth embodiments, the present invention is not restricted to this. According to the present invention, at least three substrate sound hole portions may be provided on the substrate. Further, at least two vibrating portions may be packaged on the substrate.

What is claimed is:

1. A microphone unit comprising:
a vibrating portion converting a sound to an electric signal;
a substrate having a first surface where said vibrating portion is set and a second surface opposite to said first surface and including a hollow portion transmitting a sound therein; and
a coating layer formed on an inner surface of said hollow portion of said substrate, wherein
said substrate further includes:
a first substrate sound hole portion provided on said first surface for causing said hollow portion and said vibrating portion to communicate with each other,
a second substrate sound hole portion provided on said first surface for causing said hollow portion and the exterior to communicate with each other, and
a coating liquid draining hole portion provided on said second surface for causing said hollow portion and the exterior to communicate with each other.

2. The microphone unit according to claim 1, wherein
said substrate includes a first substrate layer, a second substrate layer and a third substrate layer arranged on a side of said second substrate layer opposite to said first substrate layer,
said first substrate sound hole portion and said second substrate sound hole portion are formed on said first substrate layer,
said hollow portion is formed on said second substrate layer,
said coating liquid draining hole portion is formed on said third substrate layer, and
said coating liquid draining hole portion is sealed from the side of said second surface arranged on the side of said third substrate layer opposite to said second substrate layer.

3. The microphone unit according to claim 1, wherein
said coating liquid draining hole portion is arranged between an end portion of said first substrate sound hole portion opposite to said second substrate sound hole portion and an end portion of said second substrate sound hole portion opposite to said first substrate sound hole portion in plan view.

4. The microphone unit according to claim 1, wherein
said coating liquid draining hole portion is sealed with a sealing member different from said substrate.

5. The microphone unit according to claim 4, wherein
said coating liquid draining hole portion is sealed by being filled up with a sealing material.

6. The microphone unit according to claim 5, wherein
said sealing material is charged up to a portion close to the boundary between said coating liquid draining hole portion and said hollow portion.

7. The microphone unit according to claim 4, wherein
said coating liquid draining hole portion is sealed by being covered with a sealing film stuck to said second surface.

8. The microphone unit according to claim 4, wherein
said coating liquid draining hole portion is sealed with said coating layer.

9. The microphone unit according to claim 4, further comprising a solder joint pad arranged on a region of said second surface surrounding said coating liquid draining hole portion, wherein
said solder joint pad is soldered to a packaging substrate packaged with said microphone unit so that said coating liquid draining hole portion is sealed at least with said packaging substrate and said solder joint pad.

10. The microphone unit according to claim 1, wherein
said coating layer is formed by plating.

11. The microphone unit according to claim 1, wherein
said coating liquid draining hole portion is arranged on the outside of a region between said first substrate sound hole portion and said second substrate sound hole portion in plan view.

12. A method of manufacturing a microphone unit, comprising steps of:
forming a hollow portion transmitting a sound in a substrate having a first surface where a vibrating portion converting a sound to an electric signal is set and a second surface opposite to said first surface;
forming a first substrate sound hole portion causing said hollow portion and said vibrating portion to communicate with each other on said first surface of said substrate;
forming a second substrate sound hole portion causing said hollow portion and the exterior to communicate with each other on said first surface of said substrate;
forming a coating liquid draining hole portion causing said hollow portion and the exterior to communicate with each other on said second surface;
forming a coating layer on an inner surface of said hollow portion of said substrate; and
sealing said coating liquid draining hole portion after the formation of said coating layer.

13. The method of manufacturing a microphone unit according to claim 12, further comprising a step of forming said substrate including a first substrate layer, a second substrate layer and a third substrate layer arranged on a side of said second substrate layer opposite to said first substrate layer, wherein
said step of forming said first substrate sound hole portion includes a step of forming said first substrate sound hole portion on said first substrate layer,
said step of forming said second substrate sound hole portion includes a step of forming said second substrate sound hole portion on said first substrate layer,
said step of forming said hollow portion includes a step of forming said hollow portion on said second substrate layer,
said step of forming said coating liquid draining hole portion includes a step of forming said coating liquid draining hole portion on said third substrate layer, and
said step of sealing said coating liquid draining hole portion includes a step of sealing said coating liquid draining hole portion from the side of said second surface arranged on the side of said third substrate layer opposite to said second substrate layer.

14. The method of manufacturing a microphone unit according to claim 12, wherein
said step of forming said coating liquid draining hole portion includes a step of forming said coating liquid draining hole portion between an end portion of said first substrate sound hole portion opposite to said second substrate sound hole portion and an end portion of said second substrate sound hole portion opposite to said first substrate sound hole portion in plan view.

15. The method of manufacturing a microphone unit according to claim 12, wherein
said step of sealing said coating liquid draining hole portion includes a step of sealing said coating liquid draining hole portion with a sealing member different from said substrate.

16. An electronic apparatus comprising a microphone unit, wherein
said microphone unit includes:
a vibrating portion converting a sound to an electric signal;
a substrate having a first surface where said vibrating portion is set and a second surface opposite to said first surface and including a hollow portion transmitting a sound therein; and
a coating layer formed on an inner surface of said hollow portion of said substrate,
said substrate further includes:
a first substrate sound hole portion provided on said first surface for causing said hollow portion and said vibrating portion to communicate with each other,
a second substrate sound hole portion provided on said first surface for causing said hollow portion and the exterior to communicate with each other, and
a coating liquid draining hole portion provided on said second surface for causing said hollow portion and the exterior to communicate with each other, and
said coating liquid draining hole portion is sealed.

17. A substrate for a microphone unit, comprising:
a substrate having a first surface where a vibrating portion converting a sound to an electric signal is set and a second surface opposite to said first surface and including a hollow portion transmitting a sound therein; and
a coating layer formed on an inner surface of said hollow portion of said substrate, wherein
said substrate further includes:
a first substrate sound hole portion provided on said first surface for causing said hollow portion and said vibrating portion to communicate with each other,
a second substrate sound hole portion provided on said first surface for causing said hollow portion and the exterior to communicate with each other, and
a coating liquid draining hole portion provided on said second surface for causing said hollow portion and the exterior to communicate with each other, and
said coating liquid draining hole portion is sealed.

18. The substrate for a microphone unit according to claim 17, wherein
said substrate includes a first substrate layer, a second substrate layer and a third substrate layer arranged on a side of said second substrate layer opposite to said first substrate layer,
said first substrate sound hole portion and said second substrate sound hole portion are formed on said first substrate layer,
said hollow portion is formed on said second substrate layer,
said coating liquid draining hole portion is formed on said third substrate layer, and
said coating liquid draining hole portion is sealed from the side of said second surface arranged on the side of said third substrate layer opposite to said second substrate layer.

19. The substrate for a microphone unit according to claim 17, wherein
said coating liquid draining hole portion is arranged between an end portion of said first substrate sound hole portion opposite to said second substrate sound hole portion and an end portion of said second substrate sound hole portion opposite to said first substrate sound hole portion in plan view.

20. A method of manufacturing a substrate for a microphone unit, comprising steps of:
forming a hollow portion transmitting a sound in a substrate having a first surface where a vibrating portion converting a sound to an electric signal is set and a second surface opposite to said first surface;
forming a first substrate sound hole portion causing said hollow portion and said vibrating portion to communicate with each other on said first surface of said substrate;
forming a second substrate sound hole portion causing said hollow portion and the exterior to communicate with each other on said first surface of said substrate;
forming a coating liquid draining hole portion causing said hollow portion and the exterior to communicate with each other on said second surface;
forming a coating layer on an inner surface of said hollow portion of said substrate; and
sealing said coating liquid draining hole portion after the formation of said coating layer.
